(19) United States
(12) Patent Application Publication
(10) Pub. No.: US 2020/0389507 A1
(43) Pub. Date: Dec. 10, 2020

(54) EARLY REACHABILITY/CONNECTIVITY CHECK FOR MEDIA PATH SETUP

(71) Applicant: Avaya Inc., Santa Clara, CA (US)

(72) Inventors: Dusan Mudric, Ottawa (CA); Ping Lin, Tottenham (CA)

(21) Appl. No.: 16/434,809

(22) Filed: Jun. 7, 2019

(51) Int. Cl. H04L 29/06; H04L 12/18; H04M 7/00; H04L 12/26

(52) U.S. Cl. CPC H04L 65/403; H04L 12/185; H04L 12/1886; H04L 65/1069; H04M 7/0075; H04L 43/0811; H04L 65/1006

(57) ABSTRACT

A method of updating/reordering the priority of a remote candidate list based on an early determination of connectivity. In one embodiment, the method of system comprises performing connectivity checks for routing table entries early and generating a reachable list. In another embodiment, the method and systems prioritize the remote candidate list based on a reachable list. When a session request is received, the remote candidate list can be compared to the reachable list and addresses in the remote candidate list with prefixes that match prefixes in the reachable list are given the highest priority. The enhanced connectivity provides for a better user experience and avoids initial delays between initial signaling and the start of media flow.

### FIELD OF THE DISCLOSURE

The present disclosure is generally directed toward communications and more particularly toward early reachability and connectivity check for media path selection and setup for communications.

### BACKGROUND

Communication devices are used for voice and video calling, video conferencing, gaming, Internet access, media streaming, data messaging, email, machine-to-machine data transfers, computerized information services, and the like. Communication devices exchange data with communication systems to provide these various data services. The communication devices may be phones, smartphones, computers, laptops, tablets, wearable devices, media players, intelligent machines, and the like. Devices may communicate with other devices on the same network, and/or may communicate with devices on other networks. When devices want to communicate with devices on other networks, the communications may be transferred through a gateway, which is normally a default gateway. Communication systems may include Internet Protocol (IP) networks to transfer data.

Routers perform data traffic directing functions, such as transferring data packets between networks. Data packets are sent from one router to the next, until the packets reach the destination node. A source address indicates the IP address for the sending node, and the destination address indicates the IP address for the receiving node. In many communications, data packets flow bidirectionally. Routers advertise their information, such as prefix information, using Router Advertisement messages. The prefix information indicates the addresses that are reachable through the router. The Router Advertisement messages may also include next-hop information, for the next router in the packet route. Each router generates and maintains a routing table that lists preferred packet routes.

### SUMMARY

Embodiments of the present disclosure seek to enhance media path setup for Internet communications, such as Voice over Internet Protocol (VoIP) connections (or other similar type of IP connection) by reducing the number of probe attempts required to establish and/or maintain a connection. When a device tries to connect to an endpoint using multiple addresses or paths, the strain caused by the multiple probe attempts is further exacerbated. For example, in traditional session setup, each device performs at least one probe each (i.e., one by the called device and another by the calling device). The number of probes further increases when the first probe fails to establish a connection. This problem can be further intensified if a device is connecting to multiple endpoints.

Embodiments of the present disclosure propose the ability to prioritize reachable addresses in a routing table to eliminate the need to perform probes at the time of session setup, or at least reduce the number of probes necessary to establish a connection. Embodiments of the present disclosure also propose to generate and maintain routing lists that include up to date reachability information for each routing entry. Advantageously, the present disclosure will enhance the user's experience by avoiding initial media delays and reduce traffic on the network and/or at the user's end device. The methods discussed herein may be performed by either the offeror or the answerer device, and/or any of device in the communication path. For example, the described methods may be performed by the host and/or gateway device.

It is, therefore, one aspect of the present disclosure to provide a method of prioritizing candidate IP addresses for media paths in a communication session. In some embodiments, the communication session includes a session between two or more devices. It should be appreciated that each end device (originating and terminating) in the communication session may utilize the method described herein to select media paths for the associated media streams. It should be further appreciated that each end device may select different media paths from one another for egress and ingress. That is to say, a device may receive media over one path and transfer media over another. Additionally, media may be received and/or transferred over different paths based on media type. For example, a device may send audio data over one path and video data over another path. Using the example of two devices, both transferring audio and video, up to four different paths may be selected. In some embodiments, the method described herein is also used by a gateway device connected to multiple endpoints. Although in the examples illustrated herein IPv6 addresses are used, it should be understood that same method may be applied to any device that uses IP addresses to communicate, and single network or multihomed devices.

In this model a device, such as a host and/or default gateway, may generate and manage a routing table for routing data across a communication network, two or more communication networks, etc. The routing table may be generated by broadcasting or multicasting router solicitation (RS) messages, and, in response, receiving router advertisement (RA) messages. In some embodiments, the RA messages include destination routes, which may be the address for the ingress router on the same subnet as the destination host. For example, a host may send a Router Solicitation message and receive Router Advertisements from a default router on the local link (i.e., the same link that the host is on). Router advertisement messages may include information about router preferences and more specific routes. The specific routes may be for remote ingress routers (or at least the subnet prefixes for such routers). For example, there may be multiple Internet Service Providers (ISPs) servicing the remote host. The more specific routes may be the different routes for the different ISPs. The specific routes or IP addresses are checked for connectivity before a session invite. The host maintains a reachable list for the specific routes, so that when a session invite is received, a connection may be established without performing a probe.

For example, Hosts X, Y, and Z may transfer the following in their respective RA messages:

| Host X: | Host Y: | Host Z: |
|---|---|---|
| 2000:1:1aaa::100 | 3000:1:1aaa::100 | 4000:1:1aaa::100 |
| 2000:2:1aaa::100 | 3000:2:1aaa::100 | 4000:2:1aaa::100 |
| 2000:3:1aaa::100 | 3000:3:1aaa::100 | 4000:3:1aaa::100 |

In some embodiments, routers may also send Redirect messages to the host, directing the host to use a different router for a specific destination. The information received in the Router Advertisements and the Redirect messages may be used by the Host to generate a routing table and/or reachable list. Although a host device is discussed, it should be appreciated that this method of prioritizing a routing table may be used by any device that selects addresses, such as, but not limited to, hosts, endpoints, remote devices, gateways, etc.

Entries in the routing table have a prefix, prefix length, preference value, lifetime, and next-hop router. When a router receives a Router Advertisement, it modifies its routing table as follows. When processing a Router Advertisement, the Host first updates a ::/0 route based on the Router Lifetime and Default Router Preference in the Router Advertisement message header. Then as the Host processes the Route Information Options in the Router Advertisement message body, it updates its routing table for each such option. The Router Preference and Lifetime values in a ::/0 Route Information Option override the preference and lifetime values in the Router Advertisement header.

Updating each route may be done as follows. A route is located in the Routing Table based on the prefix, prefix length, and next-hop router. If the received route's lifetime is zero, the route is removed from the Routing Table, if present. If the route's lifetime is non-zero, the route is added to the Routing Table, if not present, and the route's lifetime and preference are updated if the route is already present.

A router's candidate address list may contain local addresses and/or remote addresses, which may block probes by applying ingress filtering. A local device would be unable to connect using the remote addresses, and probes to addresses to destinations behind routers applying ingress filtering would fail. Unnecessarily probing unreachable addresses causes delays between the initial signaling and the start of media flow, which may be perceived by the user. By prioritizing the addresses in the remote candidate list and/or routing table, unnecessary probes may be avoided.

In some embodiments, a host may check its own routing table for specifically provisioned routes that apply to a prefix of an address in a remote candidate list (or the full candidate address where possible). If there is a route to a prefix of the remote candidate address, then that candidate address is considered reachable and should have a higher priority than candidate addresses where there is no route to the prefix. Candidate addresses where there is no prefix/route in the routing table, may remain on the list to be probed, since the addresses may be behind a Network Address Translation (NAT) device; however, the addresses may be assigned a lower preference/priority.

For example, Hosts X, Y, and Z reside at different geographic locations. Each of these hosts has 3 addresses:

| Host X: | Host Y: | Host Z: |
|---|---|---|
| 2000:1:1aaa::100 | 3000:1:1aaa::100 | 4000:1:1aaa::100 |
| 2000:2:1aaa::100 | 3000:2:1aaa::100 | 4000:2:1aaa::100 |
| 2000:3:1aaa::100 | 3000:3:1aaa::100 | 4000:3:1aaa::100 |

Initially, the x000:1:1aaa::100 addresses have the highest precedence, the x000:2:1aaa::100 addresses have intermediate precedence, and the x000:3:1aaa::100 address have the lowest precedence. Routers 2000:1:1aaa::100 and 2000:2:1aaa::100 have ingress filtering to screen out connection attempts coming from addresses that do not start with “3000.” Router 4000:3:1aaa::100 advertises the 2000:3:1aaa prefix.

If Host X (offeror) communicates with Host Z (answerer), Host X will transfer its candidate list to Host Z. In this example, the remote candidate list that Host Z receives from Host X contains three addresses with 2000:1:1aaa::100 having the highest precedence, followed by 2000:2:1aaa::100, and then 2000:3:1aaa::100. When Host Z builds its list of address pairs, it will pair these three addresses with each of its own three addresses:

2000:1:1aaa::100-4000:1:1aaa::100
2000:1:1aaa::100-4000:2:1aaa::100
2000:1:1aaa::100-4000:3:1aaa::100
2000:2:1aaa::100-4000:1:1aaa::100
2000:2:1aaa::100-4000:2:1 aaa::100
2000:2:1aaa::100-4000:3:1aaa::100
2000:3:1aaa::100-4000:1:1aaa::100
2000:3:1aaa::100-4000:2:1aaa::100
2000:3:1aaa::100-4000:3:1aaa::100

The addresses may be probed in this order, based on the initial precedence assigned to each address. In the worst case, 3×3=9 address pairs will be probed, or on average 4-5 address pairs will be probed before making a successful connection. However, routers 2000:1:1aaa::100 and 2000:2:1aaa::100 use ingress filtering for addresses starting with “3000,” so the first six probes sent from 4000 addresses would fail.

Alternatively, Host Z probes each address on the 2000:: subnet first, and discovers that two or the addresses are unreachable.

2000:1:1aaa::100-4000:1:1aaa::100—unreachable due to ingress filtering
2000:2:1aaa::100-4000:1:1aaa::100—unreachable due to ingress filtering
2000:3:1aaa::100-4000:1:1aaa::100—only one reachable route to Host X

The unreachable addresses may be added to a list, or marked in the routing table, so that Host Z knows the addresses are unreachable. Similarly, the reachable address may be placed in a reachable list and/or otherwise indicated. Therefore, when a communication session is established Host Z can automatically skip the unreachable addresses.

With route enhancement, when Host Z receives the list of three remote candidate addresses from Host X, Host Z will look in its own routing table and upon finding an entry for 2000:3:1aaa:/48, obtained from router 4000:3:1aaa::100's Router Advertisement message advertising the 2000:3:1::aaa prefix, would prioritize 2000:3:1aaa::100 higher than the other two remote candidate addresses (2000:1:1aaa::100 and 2000:2:1aaa::100). With the new priority/precedence, the addresses would be probed as follows:

2000:3:1aaa::100-4000:1:1aaa::100
2000:3:1aaa::100-4000:2:1aaa::100
2000:3:1aaa::100-4000:3:1aaa::100
2000:1:1aaa::100-4000:1:1aaa::100
2000:1:1aaa::100-4000:2:1aaa::100
2000:1:1aaa::100-4000:3:1aaa::100
2000:2:1aaa::100-4000:1:1aaa::100
2000:2:1aaa::100-4000:2:1aaa::100
2000:2:1aaa::100-4000:3:1aaa::100

After the reprioritization, the three pairs at the top of the list of address pairs are more likely to be reachable, and on average 1-2 probes will be sufficient to result in a successful determination that the address is reachable and/or to establish a connection. In some cases, where there is a directly provisioned route to one of the remote addresses in the candidate list, (i.e. a static route in an out-of-band management configuration) one connectivity check may be sufficient. By comparing the remote candidate list to a reachable list, unreachable addresses are skipped.

In one example a SIP phone sends its list of candidate addresses in a SIP INVITE message and the answerer device and/or gateway device checks if some of the addresses in the remote candidate list received from the SIP phone are also in its routing table/reachable list, these addresses are prioritized over addresses that are not in the answerer's reachable list. As a host and/or gateway device is constantly maintaining the reachable list by probing the addresses in the reachable list, the host and/or gateway device knows if an address is reachable without waiting for a session request to perform the probe.

In this example, the answerer device may send a SIP 200 OK message with its own list of addresses prioritized based on the remote candidate list received from the SIP phone (i.e., calling device). The SIP phone prioritizes it's address list based the answerer device's reachability list and the addresses in the SIP 200 OK message. After the SIP 200 OK message, both the offeror and answerer have the prioritized list, where the top addresses are reachable. The devices each select one or more addresses and start streaming media to the selected addresses without performing a probe. In the case, where one or more of the selected addresses is unreachable, a probe may be performed, as in a traditional session setup. A host selects the source address based on a reachable destination address. In some examples, a Socket API uses DASA, where Rule 1 prefers reachable destinations. The reachability checks are performed before DASA Rule 1.

In another embodiment, a host may perform connectivity checks for routing table entries, prior to a connection request. For example, routes may be checked when a Router Advertisement message is received. A Host may send Solicitation messages, and routers may respond to the Client Solicitation with a Router Information Option message containing a prefix and/or IP address. When the Host adds the prefix and/and IP address to its routing table, the Host can also perform a connectivity check against the IP address (if supplied). If a prefix is supplied, the Host can use the heuristic of appending “::1” to the prefix to “guess” the router's IP address and perform a connectivity check against the “guessed” IP address. The Host may check any and all possible IP addresses in this manner.

The result (i.e. reachable/unreachable) of the connectivity check may be stored in the routing table along with the prefix and/or IP address, and used to prioritize the route. The connectivity check may be repeated periodically. Additionally, the results may be updated accordingly. In some embodiments, by using the results of the connectivity check, probes may be skipped altogether.

Advantageously, enhanced connectivity, reduces the address space over with media path connectivity checks need to be performed, which reduces the number of checks required. Additionally, preemptively performing the connectivity checks spreads the probes out and reduces connection setup time. Enhanced connectivity improves the user experience and increases the bandwidth for devices connecting to other devices using multiple addresses and/or gateways connected to multiple endpoint devices.

In other words, it is an aspect of the present disclosure to enhance media path setup by prioritizing routes and/or performing preemptive connectivity checks. In some embodiments, a Host may use its own routing table to prioritize remote addresses in a candidate list. For example, if a prefix is included in the Host's own routing table, remote addresses with that prefix may be prioritized over remote addresses with other prefixes. Additionally, a Host may preemptively perform connectivity checks and store the results of the connectivity checks in a routing table along with the prefix and/or IP address.

In some embodiments, a method is provided that generally comprises:

A method of using enhanced connectivity in session setup, the method comprising:

multicasting a solicitation message, and in response, receiving one or more addresses in an advertisement message;

probing the one or more addresses in the advertisement message to determine if each of the one or more addresses is reachable:
if the address is reachable, then adding the address to a reachable list;
if the address is not reachable, then skipping the address;

receiving a communication session request that includes an offeror's candidate list;

prioritizing the offeror's candidate list based on the reachable list to generate a prioritized offeror's candidate list;

selecting at least one address from the prioritized offeror's candidate list;

generating and transferring an answerer's candidate list; and

transferring media over the selected at least one selected address from the prioritized offeror's candidate list.

In another embodiment, a device using enhanced connectivity for session setup is provided, the device comprising:

a transceiver configured to multicast a solicitation message, and in response, receive one or more addresses in an advertisement message;

the transceiver configured to probe the one or more addresses in the advertisement message to determine if each of the one or more addresses is reachable:
if the address is reachable, then a processor configured to, add the address to a reachable list;
if the address is not reachable, then the processor configured to skip the address;

the transceiver configured to receive a communication session request that includes an offeror's candidate list;

the processor configured to prioritize the offeror's candidate list based on the reachable list to generate a prioritized offeror's candidate list;

the processor configured to select at least one address from the prioritized offeror's candidate list;

the processor configured to generate an answerer's candidate list;

the transceiver configured to transfer the answerer's candidate list and the transceiver configured to transfer media over the at least one selected address from the prioritized offeror's candidate list.

In another embodiment, a non-transitory computer-readable medium is provided. The non-transitory computer-readable medium storing one or more programs, the one or more programs comprising instructions, which when executed by an electronic device cause the electronic device to implement a method for enhanced connectivity, comprising:

multicasting a solicitation message, and in response, receiving one or more addresses in an advertisement message;

probing the one or more addresses in the advertisement message to determine if each of the one or more addresses is reachable:
if the address is reachable, then adding the address to a reachable list;
if the address is not reachable, then skipping the address;

receiving a communication session request that includes an offeror's candidate list;

prioritizing the offeror's candidate list based on the reachable list to generate a prioritized offeror's candidate list;

selecting at least one address from the prioritized offeror's candidate list;

generating and transferring an answerer's candidate list; and

transferring media over the at least one selected address from the prioritized offeror's candidate list.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be a graph database as described herein. Accordingly, the disclosure is considered to include a tangible storage medium and prior art-recognized equivalents and successor media, in which the software implementations of the present disclosure are stored.

The terms “determine”, “calculate”, and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

### BRIEF DESCRIPTION OF THE DRAWINGS

The present disclosure is described in conjunction with the appended figures:

FIG. 1A is a block diagram depicting a communication system in accordance with embodiments of the present disclosure;

FIG. 1B is a block diagram depicting a communication system in accordance with embodiments of the present disclosure;

FIG. 1C is a block diagram depicting a communication system in accordance with embodiments of the present disclosure;

FIG. 2 illustrates examples of remote candidate lists in accordance with embodiments of the present disclosure;

FIG. 3 is a flow diagram depicting enhanced connectivity for media path setup in accordance with embodiments of the present disclosure;

FIG. 4 is a flow diagram depicting enhanced connectivity for media path setup in accordance with embodiments of the present disclosure;

FIG. 5A illustrates an example routing table;

FIG. 5B illustrates the example routing table reprioritized using enhanced connectivity in accordance with the present disclosure;

FIG. 6 is a block diagram of a computer used to implement the method to enhance media path setup in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

It should be appreciated that embodiments of the present disclosure can be utilized in numerous address selection scenarios.

Furthermore, while the illustrative embodiments herein show the various components of a system collocated, it is to be appreciated that the various components of the system can be located at distant portions of a distributed network, such as a communication network and/or the Internet, or within a dedicated secure, unsecured, and/or encrypted system. Thus, it should be appreciated that the components of the system can be combined into one or more devices, such as an enterprise server or collocated on a particular node of a distributed network, such as an analog and/or digital communication network. As will be appreciated from the following description, and for reasons of computational efficiency, the components of the system can be arranged at any location within a distributed network without affecting the operation of the system. For example, the various components can be located in a device, a local server, at one or more users' premises, or some combination thereof.

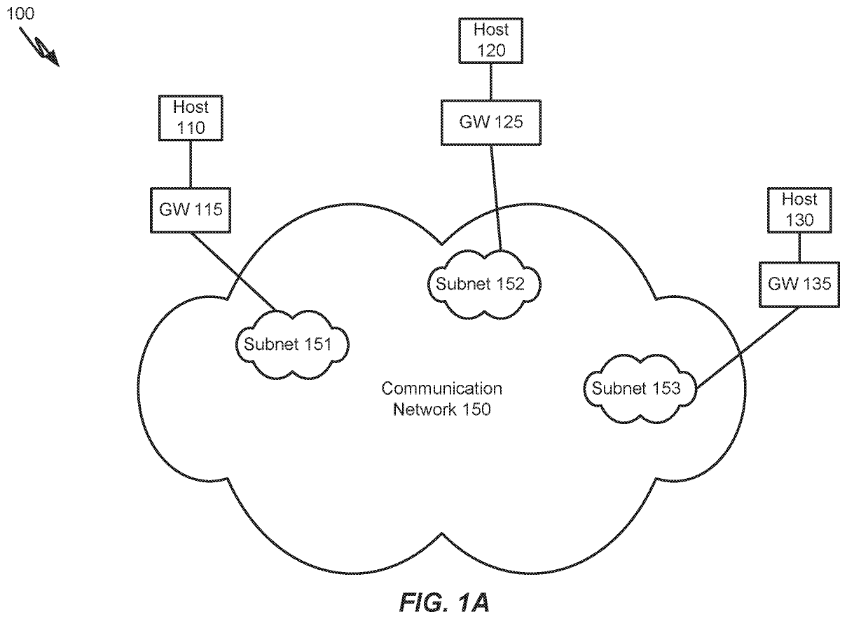

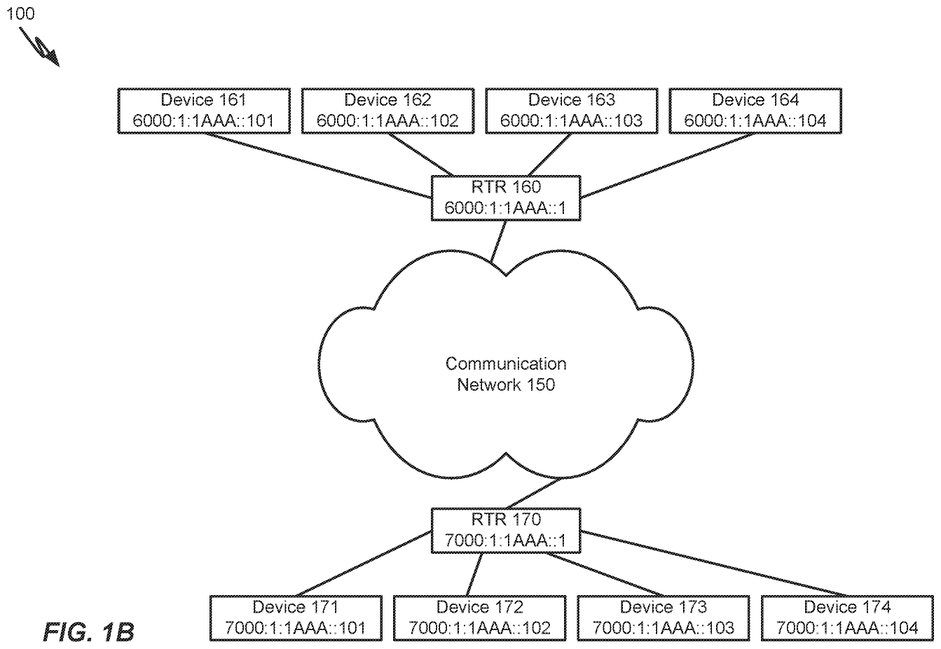

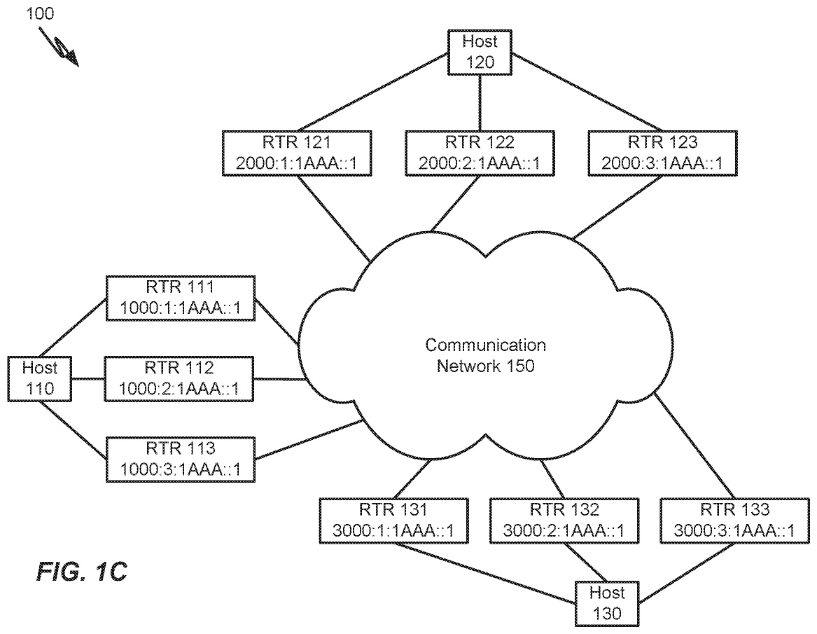

FIG. 1A illustrates a communication system 100 comprising a communication network 150 with multiple subnets 151, 152, 153. A subnetwork or subnet may correspond to a logical subdivision of an IP network. The practice of dividing a network into two or more networks is called subnetting. Devices that belong to the same subnet are addressed with an identical most-significant bit-group in their IP addresses. This results in the logical division of an IP address into two fields, the network number or routing prefix and the rest field or host identifier. The rest field is an identifier for a specific host or network interface. Traffic is exchanged between subnetworks through routers when the routing prefixes of the source address and the destination address differ.

FIG. 1A illustrates hosts 110, 120, and 140; gateway devices 115, 125, and 135, and subnets 151, 152, and 153 that are connected via communication network 150. As illustrated, host 110 is connected to gateway device 115 and subnet 151. Host 120 is connected to gateway device 125 and subnet 152. Host 130 is connected to gateway device 135 and subnet 153.

A router and/gateway device may be connected to multiple endpoint devices, as illustrated in FIG. 1B. As illustrated, router 160 is on subnet 6000:1:1aaa::1 and can reach devices with that prefix, such as devices 161-164. Router 170 is on subnet 7000:1:1aaa::1 and can reach devices with that prefix, such as devices 171-174.

With reference now to FIG. 1C, an illustrative communication system 100 in which media path setup and/or selection is enhanced as will be described in accordance with at least some embodiments of the present disclosure. The system 100 is shown to include hosts 110, 120, and 130, routers 111-113, 121-123, and 131-133, and communication network 150. Host 110 is connected to routers 111-113, host 120 is connected to routers 121-123, and host 130 is connected to routers 131-133. In other words, hosts 110, 120, and 130, connect to communication network 150 via their connected routers.

In accordance with at least some embodiments of the present disclosure, the communication network 150 may comprise any type of known communication medium or collection of communication media and may use any type of protocols to transport messages between endpoints. The communication network 150 may include wired and/or wireless communication technologies. The Internet is an example of a communication network 150 that constitutes and Internet Protocol (IP) network consisting of many computers, computing networks, and other communication devices located all over the world, which are connected through many telephone systems and other means. Other examples of communication networks include, without limitation, a standard Plain Old Telephone System (POTS), an Integrated Services Digital Network (ISDN), the Public Switched Telephone Network (PSTN), a LAN, a WAN, a Session Initiation Protocol (SIP) network, a Voice over IP (VoIP) network, a cellular network, an enterprise network, and any other type of packet-switched or circuit-switched network known in the art. In addition, it can be appreciated that communication network 150 need not be limited to any one network type, and instead may be comprised of a number of different networks and/or network types. Moreover, communication network 150 may comprise a number of different communication media such as coaxial cable, copper cable/wire, fiber-optic cable, antennas for transmitting/receiving wireless messages, and combinations thereof.

Although, only one network is shown for clarity, in some embodiments, hosts 110, 120, 130 may be located on different networks. For example, host 110 may be connected to a public network (e.g., the Internet), and hosts 120 and 130 may be connected to private networks administered by a private enterprise with personalized security rules.

In some embodiments, hosts 110, 120, and 130 may include a personal communication device or a shared communication device (e.g., a conference phone). Examples of suitable hosts 110, 120, and 130 include, without limitation, a telephone, a softphone, a cellular phone, a multi-speaker communication device (e.g., conference phone), a video phone, a PC, a laptop, a tablet, a PDA, a smartphone, a thin client, or the like. Hosts 110, 120, and 130 may be pure consumers of audio/video (e.g., having a speaker only and/or having a screen only), pure producers of audio/video (e.g., having a microphone and/or camera only), or consumers and producers of audio/video. It should be appreciated that hosts 110, 120, and 130 may be configured to support single or multi-user interactions with other network-connected devices within an enterprise communication network and/or across multiple communication networks.

In some embodiments, the calling party send a list of its addresses in the SIP INVITE message, and the called party compares the list of addresses in the SIP INVITE with addresses in its own routing table and/or reachable list. Based on the comparison, the called party prioritizes its remote candidate list before sending its remote candidate list to the calling party. The called device sends the prioritized remote candidate list to the calling device in a SIP 200 OK message. The calling party receives the SIP 200 OK message with the prioritized remote candidate list. The calling party may prioritize its destination list based on the information from the called device and selects the address with the highest priority and media negotiation is done and the communication session is established. In other words, since connectivity checks or probing are performed in the background prior to any session requests, the devices already know which addresses are reachable or unreachable before receiving a request for a communication session. In some embodiments, the calling party is notified of the one or more addresses selected by the called party, and notes this as the calling party's source address(s), and vice versa.

For example, hosts 110, 120, and 130 reside at different geographic locations. Each of these hosts has 3 addresses:

| Host 110: | Host 120: | Host 130: |
|---|---|---|
| 1000:1:1aaa::100 | 2000:1:1aaa::100 | 3000:1:1aaa::100 |
| 1000:2:1aaa::100 | 2000:2:1aaa::100 | 3000:2:1aaa::100 |
| 1000:3:1aaa::100 | 2000:3:1aaa::100 | 3000:3:1aaa::100 |

Initially, the x000:1:1aaa::100 addresses have the highest precedence, the x000:2:1aaa::100 addresses have intermediate precedence, and the x000:3:1aaa::100 address have the lowest precedence. Routers 1000:1:1aaa::1 and 1000:2:1aaa::1 filter addresses to screen out connection attempts coming from addresses that do not start with “4000.” Router 3000:3:1aaa:1 advertises the 1000:3:1aaa prefix.

If Host 110 (offeror) communicates with host 130 (answerer), host 110 will transfer its candidate list to host 130. In this example, the remote candidate list that host 130 receives from host 110 contains three addresses with 1000:1:1aaa::100 having the highest precedence, followed by 1000:2:1aaa::100, and then 1000:3:1aaa::100. When host 130 probes each of the addresses transferred from host 110, all addresses may be reachable, since routers 1000:1:1aaa::100 and 1000:2:1aaa::100 use ingress filtering to screen out connection attempts coming from addresses that do not start with “4000,” and host 130 is on subnet 3000. Additionally, router 3000:3:1aaa:1 on the same subnet as host 130 and advertises the 1000:3:1aaa prefix. Without enhanced connectivity, host 130 may send the following remote candidate list to host 130:

3000:1:1aaa::100
3000:2:1aaa::100

3000:3:1aaa::100Using the enhanced connectivity method in accordance with the present disclosure, since router 3000:3:1aaa:1 on the same subnet as host 130 advertises the 1000:3:1aaa prefix, that prefix will be prioritized over the other two. Therefore, host 130 may reprioritize its remote candidate list, to the following, before transferring to host 110:

3000:3:1aaa::100
3000:1:1aaa::100
3000:2:1aaa::100

With route enhancement, when host 130 receives the list of three remote candidate addresses from host 110, host 130 will look in its own routing table and upon finding an entry for 1000:3:1aaa:/48, obtained from router 3000:3:1aaa::100's Router Advertisement message advertising the 1000:3:1::aaa prefix, would prioritize 1000:3:1aaa::100 higher than the other two remote candidate addresses (1000:1:1aaa::100 and 1000:2:1aaa::100). Therefore, host 130 selects 1000:3:1aaa::100 and host 110 selects 3000:3:1aaa::100.

In another example, If host 110 sends out a router solicitation message and receives a response (router advertisement message) from routers 2000:1:1aaa::100 2000:2:1aaa::100, and 2000:3:1aaa::100. When host 110 performs an early connectivity check and probes each of the addresses, all the addresses may not be reachable, since routers 2000:1:1aaa::100 and 2000:2:1aaa::100 are programmed to filter out connection attempts coming from addresses that do not start with “1000,” and host 110 is on subnet 1000. Without enhanced connectivity, Host 110 attempting to establish a connection with host 120 may try to connect using the addresses in the following order:

2000:1:1aaa::100
2000:2:1aaa::100
2000:3:1aaa::100

However, since routers 2000:1:1aaa::100 and 2000:2:1aaa::100 block addresses that start with “1000,” those addresses are unreachable from Host 110, which is on the 1000 subnet.

Using the enhanced connectivity method in accordance with the present disclosure, since Host 110 performs an early connectivity check on addresses received in router advertisement messages, it would prioritize the remote candidate list as follows:

2000:3:1aaa::100
2000:1:1aaa::100—skip
2000:2:1aaa::100—skip

When a host, in some examples, a Session Initiation Protocol (SIP) agent, send its list of addresses, the called device, and in some cases a gateway device, checks to see if any of the addresses are in its routing table's reachable list. If there are addresses whose prefixes match one or more address prefixes in the routing table/reachable list, these addresses are prioritized over addresses that do not have matching prefixes. Since the routing table's reachable list is constantly maintained by the both the offeror and answerer device and/or the gateway device, the host and/or gateway device already knows which addresses are reachable. The answerer device reprioritizes its remote candidate list based on its reachable list and sends a “SIP 200 OK” message with the reprioritized remote candidate list. The answerer device may also send the address it selected for egress, and the offeror saves that address as a source address. The answerer device can send more than one source address, where the top prioritized address is based on SASA for the top remote address. After the “SIP 200 OK” message, the offeror will prioritize the destination addresses based on the SIP 200 OK message and its reachable list, then both the offeror and answerer have the prioritized lists, where the first address is reachable, and the devices may start transferring media without performing probes.

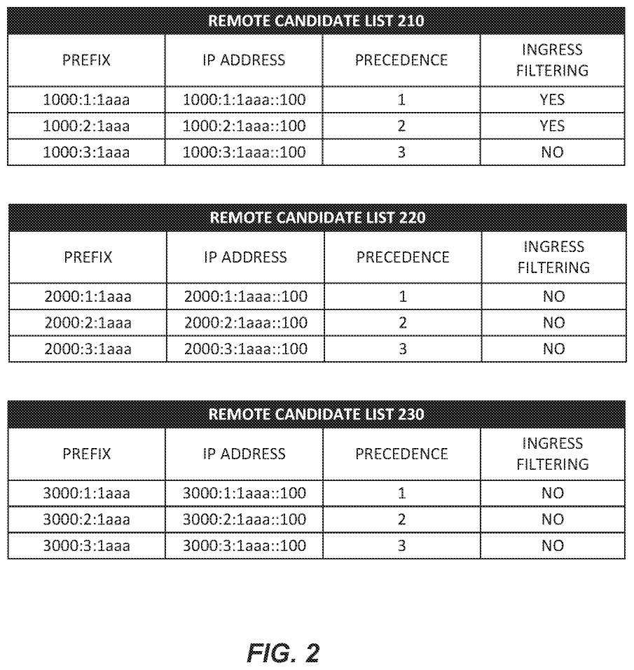

FIG. 2 illustrates remote candidate lists 210, 220, and 230 that are associated with hosts 110, 120, and 130 respectively, although other data formats are possible and in accordance with the embodiments described herein.

Remote candidate lists 210, 220, and 230 comprise the fields/columns “Prefix,” “IP Address,” “Precedence,” and “Ingress Filtering The columns listed are for illustrative purposes only, and not all columns are required, additionally, the remote candidate lists may include other columns not listed in this example.

The “Prefix” field may list a prefix for the subnet accessible by the router. The “IP address” field may list the IP address reachable by the router. The “Precedence” field may list the precedence/order of the Prefix/IP address. The “Ingress Filtering” field may indicate whether ingress filtering is activated and may also indicate the subnets that are blocked.

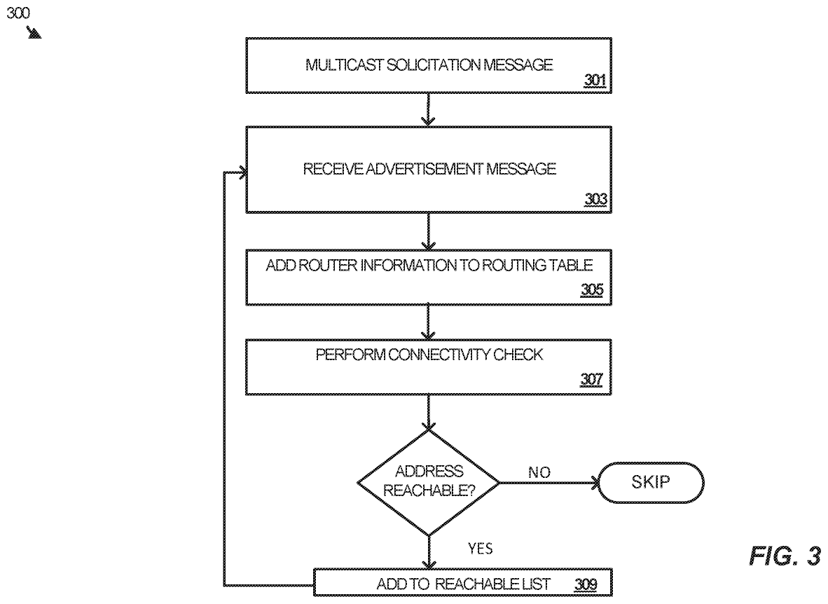

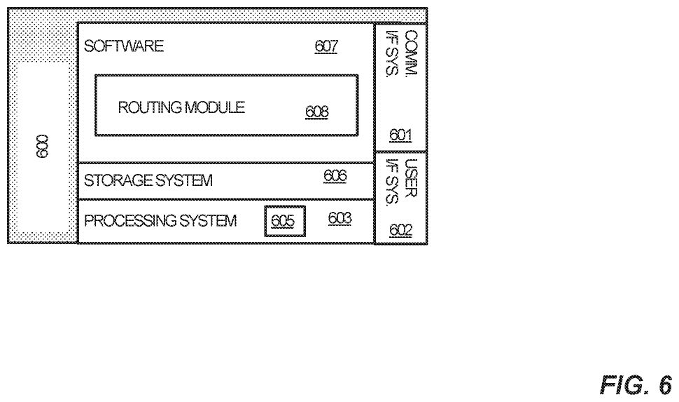

FIG. 3 illustrates a method 300 for performing early connectivity checks in accordance with at least some embodiments of the present disclosure. The method 300 are referenced parenthetically in the paragraphs that follow, along with references to the elements and systems from communication system 100 of FIG. 1. The method 300 can be executed as a set of computer-executable instructions encoded or stored on a computer readable medium and executed by the processing system 603 in FIG. 6.

While a general order for the steps of the method 300 is shown in FIG. 3, the method 300 can include more or fewer steps or can arrange the order of the steps differently than those shown in FIG. 3.

The method 300 start with a host broadcasting (or multicasting) a solicitation message (step 301). In response, the host receives one or more advertisement messages (e.g., router advertisement messages) from one or more routers (step 303). The host adds the router information from the advertisement message to its routing table (step 305). The host performs one or more connectivity checks on the addresses in its routing table (step 307). If the address is reachable (Yes), the host adds the address to a reachable list (step 309). In some embodiments, adding the address to the reachable table comprises the host updating its routing table to indicate that the address is reachable. If the address is not reachable (No), the host knows to automatically skip the address. For example, if the address is reachable it may be given a higher precedence. The hosts do routing table address probing and a SIP offeror and answerer use that knowledge to build the priority list and send media without probing, if the destinations are in the routing table and reachable. If the media transfer fails, then hosts may perform probing during the media establishment.

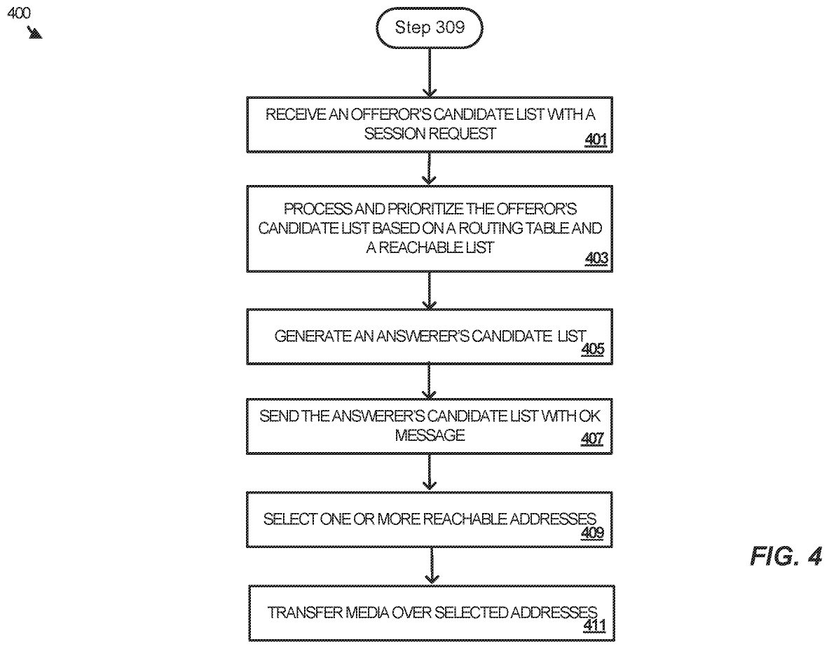

With reference now to FIG. 4, additional details of a method 400 for enhancing media path selection will be described in accordance with at least some embodiments of the present disclosure. The processes of method 400 are referenced parenthetically in the paragraphs that follow, along with references to the elements and systems from communication system 100 of FIG. 1.

While a general order for the steps of the method 400 is shown in FIG. 4, the method 400 can include more or fewer steps or can arrange the order of the steps differently than those shown in FIG. 4.

The method 400 can be executed as a set of computer-executable instructions encoded or stored on a computer readable medium and executed by the processing system 603 in FIG. 6. Alternatively, the operations discussed with respect to FIG. 4 may be implemented by the various elements of the system(s) FIG. 1. Hereinafter, the method 400 shall be explained with reference to the systems, components, assemblies, devices, user interfaces, environments, software, etc. described in conjunction with FIGS. 1-6.

As illustrated in FIG. 4, method 400, a called host receives a remote candidate list with a session request (step 401). The remote candidate list may be received in a SIP INVITE message. The called host processes and prioritizes the remote candidate list based on a routing table and a reachable list (step 403). For example, if the prefix of one of the candidate addresses is in the reachable list, then that prefix should be considered reachable and preferred. In another example, if a router blocks certain addresses and/or subnets (e.g., ingress filtering) it may block packets from an endpoint and/or gateway device. Although the endpoint and/or gateway device may not have knowledge about ingress filtering policies, when the device performs the periodic probes of the addresses in its routing table, addresses that have ingress filtering would be marked unreachable and would not be included in the reachable list. Unreachable addresses should be skipped. The called host generates its remote candidate list based on the addresses in the SIP INVITE message and its reachable list (step 405). The called host send its remote candidate list to the calling device in an accept message (step 407). For example, the calling device's candidate list may be sent in a SIP 200 OK message. The calling device compares the calling device's candidate list to its reachable list and selects an address (step 409) to transfers media (step 411).

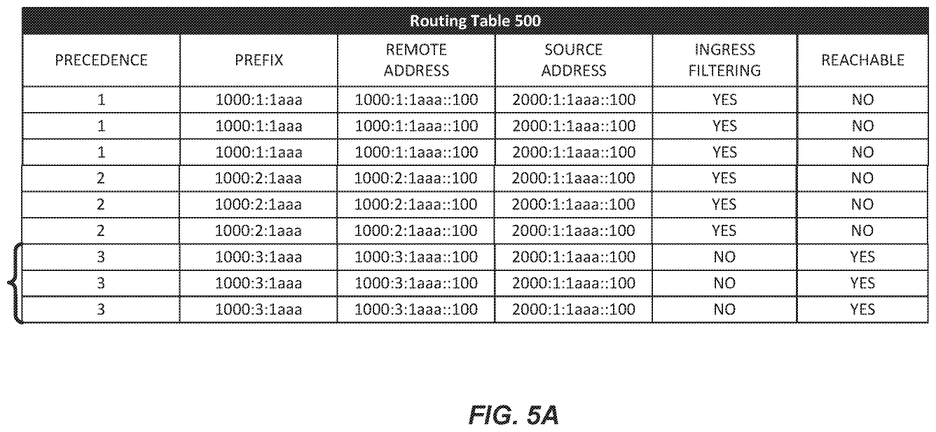

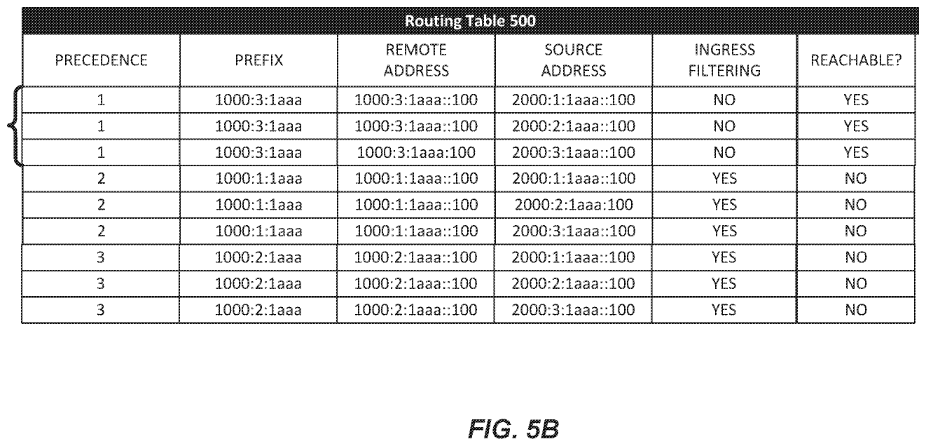

With reference now to FIG. 5A, which illustrates routing table 500. Routing table 500 is an example of a routing table in accordance to embodiments disclosed herein.

If host 120 (offeror) communicates with host 110 (answerer), host 120 will transfer its candidate list to host 110. For example, host 120 may send its list of addresses in a SIP INVITE message. In this example, the remote candidate list that host 110 receives from host 120 contains three addresses with 2000:1:1aaa::100 having the highest precedence, followed by 2000:2:1aaa::100, and then 2000:3:1aaa::100. Continuing the example above, Host 110 prioritizes its candidate list based on its reachable list and send a SIP 200 OK message with the prioritized candidate list. Host 120 will adjust its original list of addresses based on the remote candidate list in the SIP 200 OK message and/or its reachable list. In some embodiments, host 120 prioritizes or adjust its original list of addresses based on the addresses in a SIP 200 OK SDP message. Hosts 110 and 120 each select one or more reachable addresses and start the communication session. In some embodiments, Host 110 sends the reachable address it selected to host 120, and host 120 uses that address as a source address for host 110. Similarly, host 120 sends the reachable address it selected to host 110, and host 110 uses that address as a source address for host 120

With route enhancement, when Host 110 receives the list of three remote candidate addresses from host 120, host 110 will look in its own routing table and upon finding an entry for 2000:3:1aaa:/48, obtained from router 1000:3:1aaa:1's Router Advertisement message advertising the 2000:3:1:aaa prefix, would prioritize 2000:3:1aaa::100 higher than the other two remote candidate addresses (2000:1:1aaa::100 and 2000:2:1aaa::100).

The enhanced routing table 500 is illustrated in FIG. 5B. After reprioritization, the three pairs at the top of the list of address pairs are more likely to be reachable without the need to perform probes after the session request. Even in the situations where a connection cannot be established using the highest priority entry, the device can try the next entry. In some cases, where there is a directly provisioned route to one of the remote addresses in the candidate list, (i.e. a static route in an out-of-band management configuration) one probe may be sufficient to establish a connection.

FIG. 6 illustrates computing system 600 used to enhance connectivity in media path setup and/or selection as described herein, according to one implementation. Similar computing systems may be included in the gateway device, routers, PPM/SM system described herein used to generate the media path selection policies. Computing system 600 is representative of any computing system or systems with which the various operational architectures, processes, scenarios, and sequences disclosed herein for providing a communication service and selecting media paths may be implemented.

Computing system 600 is an example of hosts 110, 120, and 130, although other examples may exist. Computing system 600 comprises communication interface 601, user interface 602, and processing system 603. Processing system 603 is linked to communication interface 601 and user interface 602. Processing system 603 includes a microprocessor and/or processing circuitry 605 and memory device 606 that stores operating software 607. Computing system 600 may include other well-known components such as a battery and enclosure that are not shown for clarity. Computing system 600 may comprise a server, a user device, a desktop computer, a laptop computer, a tablet computing device, or some other user communication apparatus.

Communication interface 601 comprises components that communicate over communication links, such as network cards, ports, radio frequency (RF), processing circuitry and software, or some other communication devices. Communication interface 601 may be configured to communicate over metallic, wireless, or optical links. Communication interface 601 may be configured to use Time Division Multiplex (TDM), Internet Protocol (IP), Ethernet, optical networking, wireless protocols, communication signaling, or some other communication format—including combinations thereof. In some implementations, communication interface 601 is configured to communicate with other end user devices, wherein the communication interface is used to transfer and receive voice communications for the devices. Further, communication interface 601 may interface with a webservice, wherein the service may comprise a media streaming service, gaming service, a food ordering service, online banking service, or some other similar service that can be accessed via a website.

User interface 602 comprises components that interact with a user to receive user inputs and to present media and/or information. User interface 602 may include a speaker, microphone, buttons, lights, display screen, touch screen, touch pad, scroll wheel, communication port, or some other user input/output apparatus—including combinations thereof. User interface 602 may be omitted in some examples.

Processing circuitry 605 comprises a microprocessor and other circuitry that retrieves and executes operating software 607 from memory device 606. Memory device 606 may include volatile and nonvolatile, removable and non-removable media implemented in any method or technology for storage of information, such as computer readable instructions, data structures, program modules, or other data. Memory device 606 may be implemented as a single storage device, but may also be implemented across multiple storage devices or sub-systems. Memory device 606 may comprise additional elements, such as a controller to read operating software 607. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. It should be understood that in no case is the storage media a propagated signal.

Processing circuitry 605 is typically mounted on a circuit board that may also hold memory device 606 and portions of communication interface 601 and user interface 602. Operating software 607 comprises computer programs, firmware, or some other form of machine-readable program instructions. Operating software 607 includes routing module 608, although any number of software modules within the application may provide the same operation. Operating software 607 may further include an operating system, utilities, drivers, network interfaces, applications, or some other type of software. When executed by processing circuitry 605, operating software 607 directs processing system 603 to operate computing system 600 as described herein.

In at least one implementation, routing module 608, when read and executed by processing system 603, directs processing system 603 to update/reorder the priority of candidate address pairs based on connectivity determinization. For example, a router may have ingress filtering and be unreachable from certain address prefixes (e.g., subnets).

It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method of using enhanced connectivity in session setup, the method comprising:
multicasting a solicitation message, and in response, receiving one or more addresses in an advertisement message;
probing the one or more addresses in the advertisement message to determine if each of the one or more addresses is reachable:
if the address is reachable, then adding the address to a reachable list;
if the address is not reachable, then skipping the address;
receiving a communication session request that includes an offeror's candidate list;
prioritizing the offeror's candidate list based on the reachable list to generate a prioritized offeror's candidate list;
selecting at least one address from the prioritized offeror's candidate list;
generating and transferring an answerer's candidate list; and
transferring media over the at least one address selected from the prioritized offeror's candidate list.

2. The method of claim 1, further comprising:
periodically probing addresses in the reachable list to determine if each of the addresses is reachable:
if the address is reachable, then keeping the address in the reachable list;
if the address is not reachable, then skipping the address.

3. The method of claim 1, further comprising:
transferring the at least one address selected from the prioritized offeror's candidate list.

4. The method of claim 1, wherein the communication session request comprises a SIP INVITE message.

5. The method of claim 1, wherein transferring the answerer's candidate list comprises transferring the answerer's candidate list in a SIP 200 OK message.

6. The method of claim 1, wherein the communication session request is for a request for a Voice Over Internet Protocol (VoIP) session.

7. The method of claim 1, wherein prioritizing the offeror's candidate list based on the reachable list comprises giving addresses with prefixes matching prefixes in the reachable list a highest priority.

8. A device using enhanced connectivity for session setup, the device comprising:
a transceiver configured to multicast a solicitation message, and in response, to receive one or more addresses in an advertisement message;
the transceiver configured to probe the one or more addresses in the advertisement message to determine if each of the one or more addresses is reachable:
if the address is reachable, then a processor configured to add the address to a reachable list;
if the address is not reachable, then the processor configured to skip the address;
the transceiver configured to receive a communication session request that includes an offeror's candidate list;
the processor configured to prioritize the offeror's candidate list based on a reachable list to generate a prioritized offeror's candidate list;
the processor configured to select at least one address from the prioritized offeror's candidate list;
the processor configured to generate an answerer's candidate list;
the transceiver configured to transfer the answerer's candidate list; and
the transceiver configured to transfer media over the at least one selected address from the prioritized offeror's candidate list.

9. The device of claim 8, further comprising:
the transceiver configured to periodically probe addresses in the reachable list to determine if each of the addresses is reachable:
if the address is reachable, then the processor configured to keep the address in the reachable list;
if the address is not reachable, then the processor configured to skip the address.

10. The device of claim 8, further comprising:
the transceiver configured to transfer the at least one address selected from the prioritized offeror's candidate list.

11. The device of claim 8, wherein the communication session request comprises a SIP INVITE message.

12. The device of claim 8, wherein the transceiver is configured transfer the answerer's candidate list in a SIP 200 OK message.

13. The device of claim 8, wherein the communication session request is for a request for a Voice Over Internet Protocol (VoIP) session.

14. The device of claim 8, wherein the processor is configured to give addresses with prefixes matching prefixes in the reachable list a highest priority.

15. A non-transitory computer-readable medium storing one or more programs, the one or more programs comprising instructions, which when executed by an electronic device cause the electronic device to implement a method for enhanced connectivity, comprising:
multicasting a solicitation message, and in response, receiving one or more addresses in an advertisement message;
probing the one or more addresses in the advertisement message to determine if each of the one or more addresses is reachable:
if the address is reachable, then adding the address to a reachable list;
if the address is not reachable, then skipping the address;
receiving a communication session request that includes an offeror's candidate list;
prioritizing the offeror's candidate list based on the reachable list to generate a prioritized offeror's candidate list;
selecting at least one address from the prioritized offeror's candidate list;
generating and transferring an answerer's candidate list; and
transferring media over the at least one address selected from the prioritized offeror's candidate list.

16. The non-transitory computer-readable medium of claim 15, further comprising:
periodically probing addresses in the reachable list to determine if each of the addresses is reachable:
if the address is reachable, then keeping the address in the reachable list;
if the address is not reachable, then skipping the address.

17. The non-transitory computer-readable medium of claim 15, further comprising:
transferring the at least one address selected from the prioritized offeror's candidate list.

18. The non-transitory computer-readable medium of claim 15, wherein the communication session request comprises a SIP INVITE message.

19. The non-transitory computer-readable medium of claim 15, further comprising:
transferring the answerer's candidate list in a SIP 200 OK message.

20. The non-transitory computer-readable medium of claim 15, further comprising:
giving addresses with prefixes matching prefixes in the reachable list a highest priority.
